(19) United States
(12) Patent Application Publication
(10) Pub. No.: US 2026/0261794 A1
(43) Pub. Date: Sep. 3, 2026

(54) GRILLE INTEGRATED ACOUSTIC FILTER

(71) Applicant: QSC, LLC, Costa Mesa, CA (US)

(72) Inventors: Christopher SMOLEN, Huntington Beach, CA (US); Miodrag PEJIN

(73) Assignee: QSC, LLC, Costa Mesa, CA (US)

(21) Appl. No.: 19/552,595

(22) Filed: Feb. 27, 2026

Related U.S. Application Data
(60) Provisional application No. 63/765,127, filed on Feb. 28, 2025.

(51) Int. Cl. H04R 1/28; H04R 1/02; H04R 1/24; H04R 3/14

(52) U.S. Cl. CPC H04R 1/2842; H04R 1/023; H04R 1/025; H04R 1/24; H04R 1/2811; H04R 1/2834; H04R 3/14

(57) ABSTRACT

A loudspeaker grille having an integrated acoustic filter. The grille includes a grille body and an acoustic filter portion. The grille configured to attach to a front portion of a speaker enclosure and including an inner face defining a speaker driver covering area. The acoustic filter portion configured to be one of attached to the inner face or formed as an acoustically non-transparent portion of the grille . The acoustic filter portion configured to cover a least a portion of the speaker driver covering area, wherein the acoustic filter portion is configured to increase sensitivity in a low frequency range below a crossover frequency and narrow coverage of the low frequency speaker driver.

### CROSS-REFERENCE TO RELATED APPLICATIONS

This application claims the benefit of U.S. Provisional Application No. 63/765,127 filed February 28, 2025, which is currently pending, the disclosure of which is hereby incorporated by reference herein in its entirety.

### TECHNICAL FIELD

The present disclosure relates generally to loudspeakers, and more particularly to a loudspeaker having a grille with an integrated acoustic filter.

### BACKGROUND

Loudspeaker systems commonly employ multiple acoustic transducers arranged to reproduce different portions of the audible frequency spectrum. In many professional and consumer audio products, a low-frequency driver (e.g., a woofer) is combined with a high-frequency driver (e.g., a compression driver or tweeter) and an associated crossover network that divides the audio signal into separate frequency bands. The crossover network establishes a crossover frequency below which the low-frequency driver predominates and above which the high-frequency driver predominates.

In conventional loudspeaker enclosures, each driver is typically positioned behind a protective grille. Such grilles are generally formed from perforated metal, expanded metal mesh, molded polymer lattice, or fabric stretched across a frame. The primary purpose of the grille is mechanical protection and aesthetic concealment of the underlying drivers. To minimize acoustic interference, these grilles are typically designed to be substantially acoustically transparent across the intended operating frequency range of the loudspeaker system.

In some loudspeaker configurations, however, it is desirable to control the radiation pattern and sensitivity of a speaker driver, such as for example, a low-frequency driver. Conventional approaches to low-frequency directivity control may include larger baffle dimensions, horn loading, cardioid or end-fire array configurations, or the use of multiple spaced drivers. Such approaches can increase system size, complexity, weight, and cost.

Protective grilles have not traditionally been used as functional acoustic elements to selectively shape low-frequency output. In many commercially available loudspeaker products, the grille structure is designed to be substantially uniform across the frontal area of the enclosure. Uniform perforation or mesh patterns are employed so that the grille presents a largely consistent acoustic impedance across the face of both the low-frequency and high-frequency drivers.

It would be advantageous to provide a loudspeaker grille configuration that departs from purely protective or aesthetic functions and instead provides controlled acoustic interaction with the speaker drivers (e.g., the low-frequency driver). It may be desirable to provide for a grille with an integrated acoustic filter that selectively blocks portion of the driver aperture. Such a grille may increase on-axis sensitivity in a low-frequency range below the crossover frequency and narrow the coverage pattern of the low-frequency driver without requiring additional drivers, complex horn structures, or significant increases in enclosure size while maintaining protection.

### SUMMARY

The present disclosure provides an acoustic filter portion for a loudspeaker that is integrated with a grille of the loudspeaker. For example, a loudspeaker may have a grille-integrated acoustic filter. In some embodiments, the loudspeaker may include a first speaker driver (e.g., a low frequency speaker driver), a second speaker driver (e.g., high frequency speaker driver), and an enclosure configured to house the first frequency speaker driver and the second frequency speaker driver.

The loudspeaker may include a grille configured to attach to a front portion of the enclosure to cover at least the first frequency speaker driver with an acoustic filter portion that is one of attached to an inner face of the grille or formed as an acoustically non-transparent portion of the grille. In some embodiments, the acoustic filter portion may be configured to reflect sound waves from the first frequency speaker driver in order to increase sensitivity in a first frequency range below a crossover frequency and narrow coverage of the first frequency speaker driver.

In some embodiments, the loudspeaker is a passive loudspeaker.

In some embodiments, the loudspeaker may include a crossover circuit that is configured: to receive an audio input signal (e.g., via an input), to separate the audio input signal into a high frequency band and a low frequency band, and to transmit the high frequency band to a high frequency speaker driver and the low frequency band to a low frequency speaker driver, where the high frequency band and the low frequency band are separated at the crossover frequency.

In some embodiments, the inner face of the grille may define a low-frequency driver covering area and the acoustic filter portion may be configured to cover 25% or more of the low-frequency driver covering area. In some embodiments, the acoustic filter portion may be configured to cover 50% or more of the low-frequency driver covering area. In some embodiments, the acoustic filter portion may be configured to cover 75% or more of the low-frequency driver covering area.

In some embodiments, the acoustic filter portion may be circular-shaped or oval shaped.

In some embodiments, the grille may include a perforated portion and the acoustic filter portion may include a non-perforated portion of the grille.

In some embodiments, the acoustic filter portion may be attached to the inner face of the grille. In some embodiments, the acoustic filter portion may be transparent to light.

Some embodiments of a loudspeaker grille may include an integrated acoustic filter. In some such embodiments, the loudspeaker grille may include a grille body configured to attach to a front portion of a speaker enclosure. In some embodiments, the grille body may include an inner face defining a speaker driver covering area.

In some embodiments, an acoustic filter portion may be provided that is one of attached to the inner face or formed as an acoustically non-transparent portion of the grille. In some embodiments, the acoustic filter portion may be configured to cover a least a portion of the speaker driver covering area. In some embodiments, the acoustic filter portion may be configured to increase sensitivity in a low frequency range below a crossover frequency and narrow coverage of a low frequency speaker driver.

In some embodiments, the acoustic filter portion may be configured to cover 25% or more of the driver covering area. In some embodiments, the acoustic filter portion may be configured to cover 50% or more of the driver covering area. In some embodiments, the acoustic filter portion may be configured to cover 75% or more of the driver covering area.

In some embodiments, the acoustic filter portion may be circular shaped or oval shaped.

In some embodiments, the grille may include a perforated portion and the acoustic filter portion may include non-perforated portion of the grille.

In some embodiments, the acoustic filter portion may be attached to the inner face of the grille. In some embodiments, the acoustic filter portion may be transparent to light or otherwise difficult to see.

In some embodiments, a method for increasing sensitivity of a loudspeaker in a low frequency range below a crossover frequency may include creating an acoustically non-transparent portion of a grille for the loudspeaker and attaching the grille to the loudspeaker such that the acoustically non-transparent portion extends across at least a portion of a driver covering area of the grille.

In some embodiment, the driver covering area of the grille may overlay a low-frequency speaker driver front area of a low-frequency speaker driver of the loudspeaker such that the acoustically non-transparent portion blocks at least a portion of an audio output of the low-frequency speaker driver.

In some embodiments, the acoustically non-transparent portion may extend across at least 25% of the driver covering area of the grille. In some embodiments, the acoustically non-transparent portion may extend across at least 50% of the driver covering area of the grille. In some embodiments, the acoustically non-transparent portion may extend across at least 75% of the driver covering area of the grille.

In some embodiments, the grille may include a perforated portion. In some embodiments, creating the acoustically non-transparent portion of the grille for the loudspeaker may include creating a non-perforated portion of the grille.

In some embodiments, creating an acoustically non-transparent portion of a grille for the loudspeaker may include attaching an acoustically non-transparent material to an inner surface of the grille.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates side cross section view of an example loudspeaker having an example integrated acoustic filter.

FIG. 2 illustrates a front view of the speaker of FIG. 1.

FIG. 3 illustrates a rear view of an example grille for a loudspeaker having an example integrated acoustic filter;

FIG. 4 illustrates a rear view of an example grille for a loudspeaker having an example integrated acoustic filter;

FIG. 5 illustrates a front view of the grille of FIG. 4.

FIG. 6 illustrates an example on-axis sensitivity plot comparing a loudspeaker having an 140mm diameter circular integrated acoustic filter on the grille vs. a grille without an acoustic filter.

FIG. 7 illustrates an example horizontal contour plot comparing a loudspeaker having a 140mm diameter circular integrated acoustic filter on the grille vs. a grille without an acoustic filter.

FIG. 8 illustrates an example on-axis sensitivity plot comparing a loudspeaker having a 140mm diameter circular integrated acoustic filter on the grille vs. a 160mm diameter circular integrated acoustic filter on the grille.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

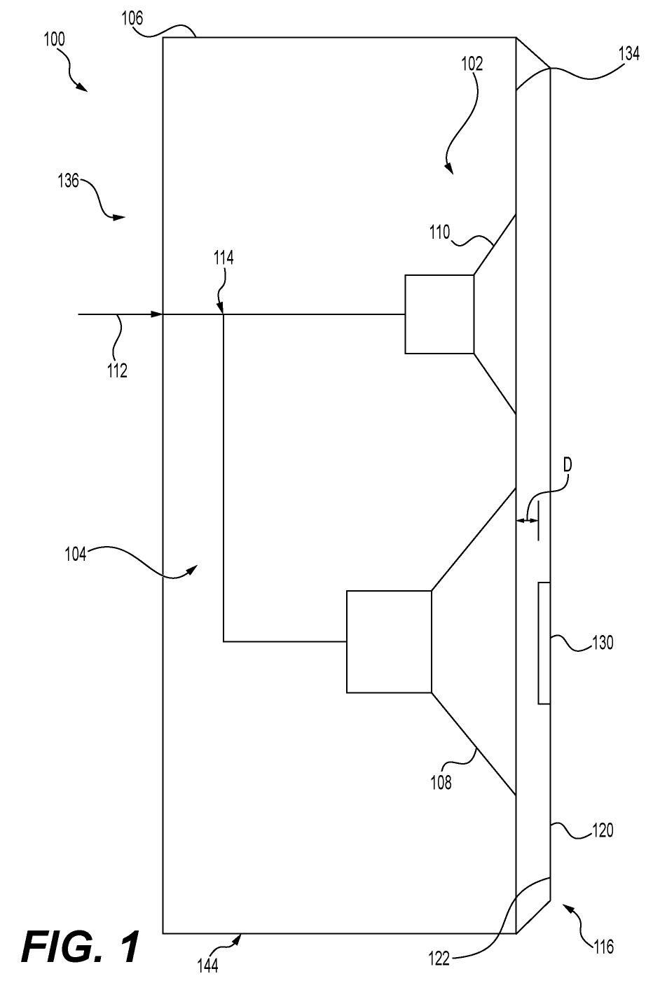

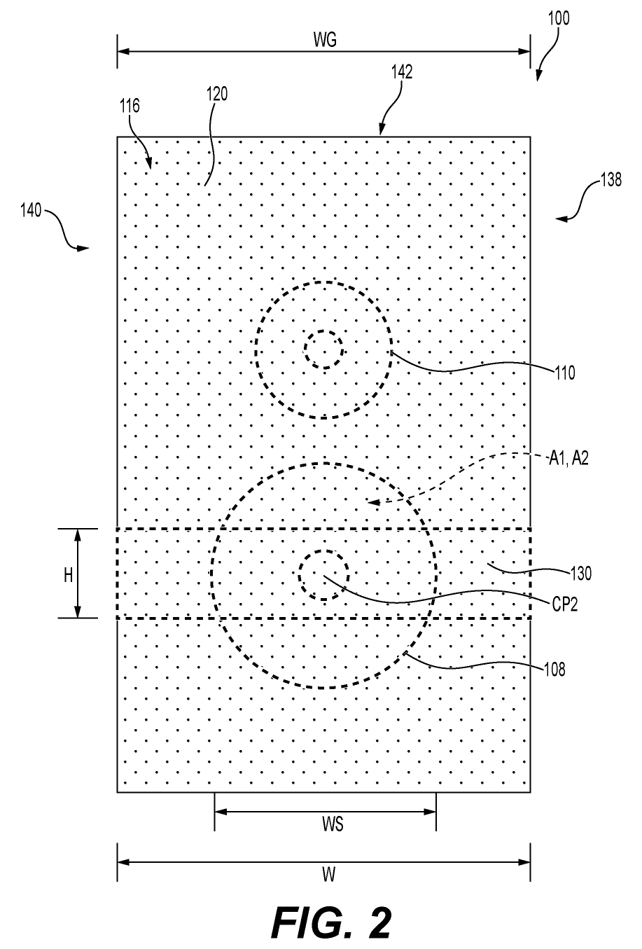

FIGS. 1-2 illustrates an example loudspeaker 100 utilizing a grille integrated acoustic filter. The loudspeaker 100 may be configured in a variety of ways. In some embodiments, the loudspeaker 100 may be passive speaker. In other embodiments, the speaker may be an active or powered speaker. In some embodiments, the loudspeaker 100 may include two or more speaker drivers 102, an electrical circuit(s) 104, and an enclosure 106 configured to house the two or more speaker drivers 102 and the electrical circuit(s) 104. The enclosure 106 may be configured in a variety of ways, including size, shape, and material. In some embodiments, the enclosure 106 may be, for example, a conventional speaker box or housing. In some embodiments, the enclosure 106 may be made from wood (e.g., medium-density fiberboard, plywood, particle board, etc.), plastic (e.g., ABS, polypropylene, etc.), composites, metals, combinations thereof, or other suitable materials.

In some embodiments, the enclosure 106 may include a front portion 134, a rear portion 136 opposite the front portion 134, a first side portion 138 extending between the front portion 134 and the rear portion 136, and second side portion 140 opposite the first side portion 138 and extending between the front portion 134 and the rear portion 136, a top portion 142 extending between the first side portion 138 and the second side portion 140, and a bottom portion 144 opposite the top portion 142 and extending between the first side portion 138 and the second side portion 140. In some embodiments, the enclosure 106 may be a cuboid shape.

The two or more speaker drivers 102 may include subwoofers (very low frequencies), woofers (low frequencies), mid-range speaker driver (middle frequencies) and tweeters (high frequencies). In some embodiments, as shown in FIGS. 1-2, the loudspeaker 100 may include a low frequency speaker driver 108 and a high frequency speaker driver 110. The two or more speaker drivers 102 may be mounted within the enclosure 106 in any suitable manner. In some embodiments, the low frequency speaker driver 108 and a high frequency speaker driver 110 may be oriented facing forward such that the audio output of the drivers is design to exit the front portion 134 of the enclosure.

In some embodiments, the electrical circuit(s) 104 may be configured to electrically connect an input 112, that is configured to receive an input electrical signal, from the rear portion 136 of the enclosure 106 to the low frequency speaker driver 108 and the high frequency speaker driver 110. In some embodiments, the electrical circuit(s) 104 may include a crossover circuit or network 114 configured to separate the input signal into different frequency bands and route the signals to the appropriate speaker drivers 108, 110 (i.e., lower frequencies to the low frequency speaker driver 108 and higher frequencies to the high frequency speaker driver 110). The crossover circuit or network 114 may be configured to define a crossover point, which is the audio frequency at which the input signal is split and filtered into different frequency ranges (i.e., the frequency at which the crossover circuit 114 starts to “hand off” the signal from one speaker driver to another speaker driver).

In some embodiments, the loudspeaker 100 may include a grille 116 configured to attach to the front portion 134 of the enclosure 106 to cover the front portion 134, providing protection to the internal components of the loudspeaker 100 (e.g., the low frequency speaker driver 108 and the high frequency speaker driver 110) from damage while allowing sound to pass through. The grille 116 may be configured in a variety of ways. In some embodiments, the grille 116 may include an outer face 120 and an inner face 122 opposite to the outer face 120. The grille 116 may be configured to attach to the enclosure 106 such that the inner face 122 is spaced apart from the front portion 134 of the enclosure 106. The grille 116 may attach to the front portion 134 of the enclosure 106 in any suitable manner (e.g., magnets, friction-fit plastic pegs, hook-and-loop fasteners (Velcro), recessed friction slots, etc.).

The grille 116 may be formed from any suitable materials. For example, in some embodiments, at least a first portion of the grille 116 may be made from a substantially acoustically transparent material (e.g., a perforated metal, a woven fabric, an expanded metal mesh, etc.) intended to minimally interfere with the acoustic output of the speaker drivers 108, 110.

In some embodiments, the grille 116 may be configured to cover one or both of the low frequency speaker driver 108 and the high frequency speaker driver 110. In some embodiments, the low-frequency speaker driver 108 may define a low-frequency speaker driver front area A1 when viewed from the front portion 134. For example, in some embodiments, the low-frequency speaker driver 108 may be round (i.e., a circular cone or diaphragm) with a diameter WS. Thus, in embodiments where the low-frequency speaker driver 108 is circular or round, the low-frequency speaker driver front area A1 is the area of the circle defined by the diameter WS. If the low-frequency speaker driver 108 were oval, the low-frequency speaker driver front area A1 would be an oval area and so forth corresponding to any shape of the low-frequency speaker driver.

When the grille 116 is attached to the front portion 134 of the enclosure 106, the grille 116 (e.g., the inner face 122) may define a driver covering area A2 that is the area of the inner face of the grille that overlays the low-frequency speaker driver front area A1. Thus, the driver covering area A2 on the grille 116 equals (i.e., matches) the low-frequency speaker driver front area A1 of the low frequency speaker driver 108.

In some embodiments, the grille 116 may include at least one integrated acoustic filtering portion 130 configured to block or reflect at least a portion of the sound emanating from the low frequency speaker driver 108 and/or high frequency speaker driver 110. The acoustic filtering portion 130 may be configured in a variety of ways, including, but not limited to, the shape, the size, the position relative to the grille, the position and distance relative to the low frequency speaker driver, and the materials used. In some embodiments, the integrated acoustic filtering portion 130 may be configured as an object positioned adjacent to (e.g., attached to) the grille 116 or may be configured as a modified portion of the grille 116 (e.g., a non-acoustically-transparent area of an acoustically transparent material). In some embodiments, the acoustic filtering portion 130 may act as an acoustic phase plug formed by an attachment to the grille 116 or by a modified portion of the grille 116.

In the illustrated example of FIGS. 1-2, the acoustic filtering portion 130 may be an acoustically non-transparent object (e.g., a solid object configured to reflect sound) attached to the inner face 122 of the grille 116 adjacent to (e.g., in front of) the low frequency speaker driver 108. In other examples, however, the acoustic filtering portion 130 may be formed as a modified portion the grille 116 that is acoustically non-transparent (e.g., a solid portion of the grille configured to reflect sound, such as a portion of a perforated metal sheet that lacks perforations or that has the perforations filled or otherwise blocked). For example, where the grille 116 includes a perforated metal sheet, the modified portion of the grille 116 may be a portion of the grille 116 that is not perforated at one or more specific locations such that sound cannot propagate through those unperforated locations. In some embodiments, the modified portion(s) may be formed at manufacturing time by controlling the stamping of the metal sheet for the grille 116 such that specific areas of the metal sheet have no perforations, few perforations, smaller perforations, or the like.

In the example of FIGS. 1-2, the acoustic filtering portion 130 may be positioned a distance D from the low frequency speaker driver 108 and the front portion 134 of the enclosure. The distance D may vary in different embodiments. The distance D from the low frequency speaker driver 108 to the acoustic filtering portion 130 may range from a minimal amount (e.g., essentially at the low frequency speaker driver 108) to any suitable distance where the acoustic filtering portion 130 may still block or reflect at least a portion of the sound emanating from the low frequency speaker driver 108 and/or high frequency speaker driver 110. For example, in some embodiments, the distance D may range from about 0.5 to about 100 mm, such as 2, 5, 12, 24, 36, 48, 60, or 72 mm, for instance. In other embodiments, the distance D may be greater than 100mm. In some embodiments, the distance D may be selected based on the desired crossover frequency. For example, in some embodiments, the distance D between the acoustic filtering portion 130 and the low frequency speaker driver 108 may play a role in the high frequency cutoff. For example, in some embodiments, the closer the acoustic filtering portion 130 is to the low frequency speaker driver 108 (i.e., smaller distance D), the higher the high frequency cutoff will be (i.e., a higher frequency).

In some embodiments, the size and position of the acoustic filtering portion 130 may be configured to impact the sensitivity and directivity of the acoustic output of the low frequency speaker driver 108 and/or the high frequency speaker driver 110. For example, in some embodiments, the acoustic filtering portion 130 may cover 25% or more, 50% or more, or 75% or more of the low-frequency driver covering area A2. In some embodiments, the acoustic filtering portion 130 may have an area that is larger low-frequency driver covering area A2 such that 100% of the low-frequency driver covering area A2 is covered by the acoustic filtering portion 130.

In some embodiments, the acoustic filtering portion 130 may be centered in the low-frequency driver covering area A2. For example, in some embodiments where the low-frequency driver 108 has a circular low-frequency speaker driver front area A1, the acoustic filtering portion 130 may be circular and positioned such that the acoustic filtering portion 130 is concentric with the low-frequency speaker driver front area A1 and low-frequency driver covering area A2. In other embodiments, however, the center of the acoustic filtering portion 130 may be offset vertically and/or horizontally from the center of the low-frequency speaker driver front area A1.

In some embodiments, the shape (e.g., thickness) of the acoustic filtering portion 130 may vary. For example, in some embodiments, the shape of the acoustic filtering portion 130 may vary to modify the distance D to be closer or further from the low frequency speaker driver 108. In some embodiments, the shape of the grille 116 may be modified to place the acoustic filtering portion 130 closer or further from the low frequency speaker driver 108. For example, the mold of the grille 116 may be controlled (e.g., creating a 3D impression as the grille is bent into its final shape) to control the distance D. Adjusting the distance D between the low frequency speaker driver 108 and the acoustic filtering portion 130 can affect how the low-frequency waves propagate. A closer acoustic filtering portion 130 (e.g., a smaller D) can create a more focused directivity pattern, while an acoustic filtering portion 130 farther from the low frequency speaker driver 108 can create a wider dispersion.

The shape of the acoustic filtering portion 130 (e.g., the object attached to the grille or the modification of the grille itself) may take any suitable form factor, for example, whatever form is conducive to achieving a desired acoustical effect, such as a sensitivity effect (e.g., on-axis sensitivity, cross-over point sensitivity, etc.), a coverage or directivity effect (e.g., beaming, etc.), a frequency effect (e.g., decreasing level at specified frequencies), etc. In the illustrated example of FIGS. 1-2, the acoustic filtering portion 130 is configured as a rectangular strip extending laterally across the grille 116. In some embodiments, the acoustic filtering portion 130 may have a width W and a height H. In some embodiments, the width W may extend across an entire width WG of the grille 116. In other embodiments, the width W may extend less than the entire width WG of the grille 116. For example, the width W may extend laterally across a width WS of the low frequency speaker driver (e.g., a diameter of a diaphragm of the speaker driver) but less than the entire width WG of the grille 116. In some embodiments, the width W may extend less than the width WG of the grille 116. For example, the width W may extend laterally less the width WS of the low frequency speaker driver 108.

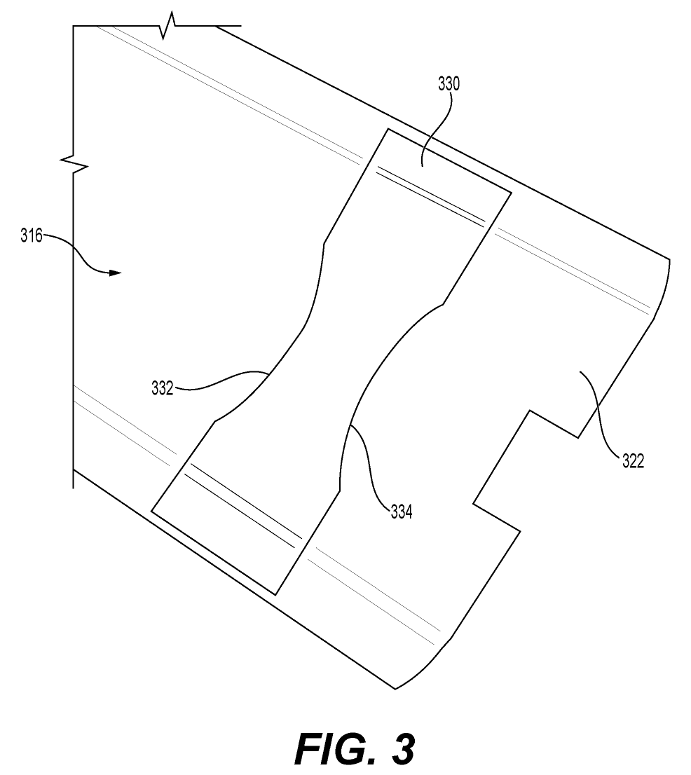

FIG. 3 illustrates another example acoustic filtering portion 330. The acoustic filtering portion 330 may be substantially similar to acoustic filtering portion 130 in that, in some embodiments, the acoustic filtering portion 330 may be attached to an inner face 322 of a grille 316 and may be configured as a rectangular strip extending laterally across the grille 316. In some embodiments, however, the acoustic filtering portion 330 may include a concave upper edge portion 332 and a concave lower edge portion 334 such that the acoustic filtering portion 330 may resemble an hourglass shape. Similar to the acoustic filtering portion 130, the height and width of the acoustic filtering portion 330 may vary in different embodiments.

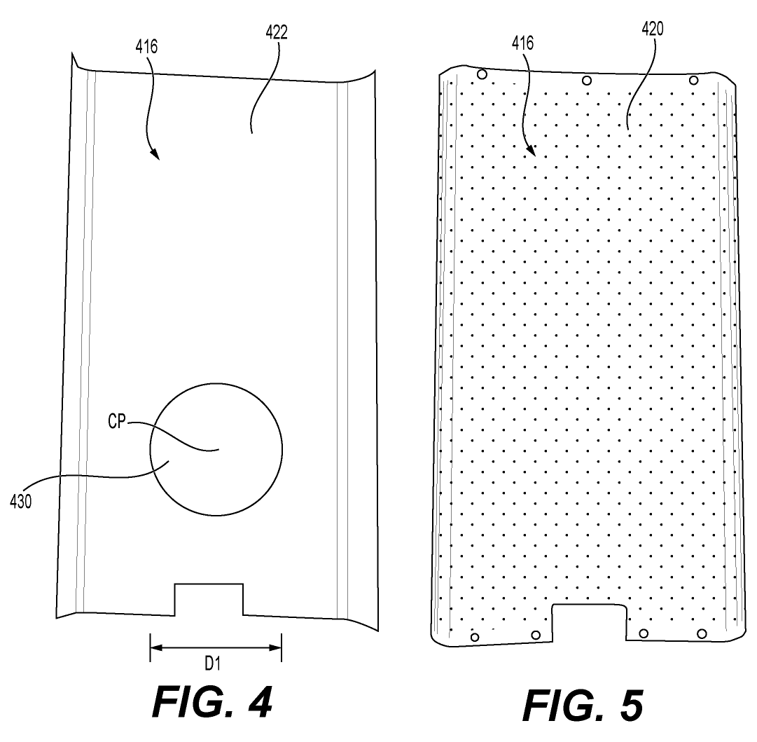

FIG. 4 illustrates another example acoustic filtering portion 430. In some embodiments, as with the acoustic filtering portion 130, the acoustic filter portion 430 may be attached to an inner face 422 of a grille 416 or may be formed as a modified portion the grille 416 (e.g., an acoustically non-transparent portion of the grille 416). In some embodiments, the acoustic filtering portion 430 may be circular or oval shaped. For example, a circular acoustic filtering portion 430, as shown in FIG. 4, may maintain a uniform directivity pattern of the soundwaves, while an oval acoustic filtering portion may create a more directional beam. In some embodiments, the acoustic filtering portion 430 may have a center point CP and a diameter D1. In some embodiments, the acoustic filtering portion 430 may be positioned on the grille 416 such that the center point CP is aligned with a center point CP2 of the low frequency speaker driver 108 (FIG. 2) (i.e., concentric). In some embodiments, the diameter D1 may be greater than the width WS of the low frequency speaker driver 108. In some embodiments, the diameter D1 may be equal to or less than the width WS of the low frequency speaker driver 108.

The acoustic filtering portion 130, 330, 430 may be made from any suitable material(s) that blocks or reflects at least a portion of the sound emanating from the low frequency speaker driver 108. For example, in some embodiments, the acoustic filtering portion 130, 330, 430 may be made from a vinyl polymer (e.g., polyvinyl chloride) or other plastic material. In some embodiments, the acoustic filtering portion 130, 330, 430 may be transparent to light or otherwise difficult to detect with the human eye. For example, as shown in FIG. 5, when viewed from an outer face 420, the visibly transparent acoustic filtering portion 430 is not readily apparent to the eye, even though the grille 416 may be perforated.

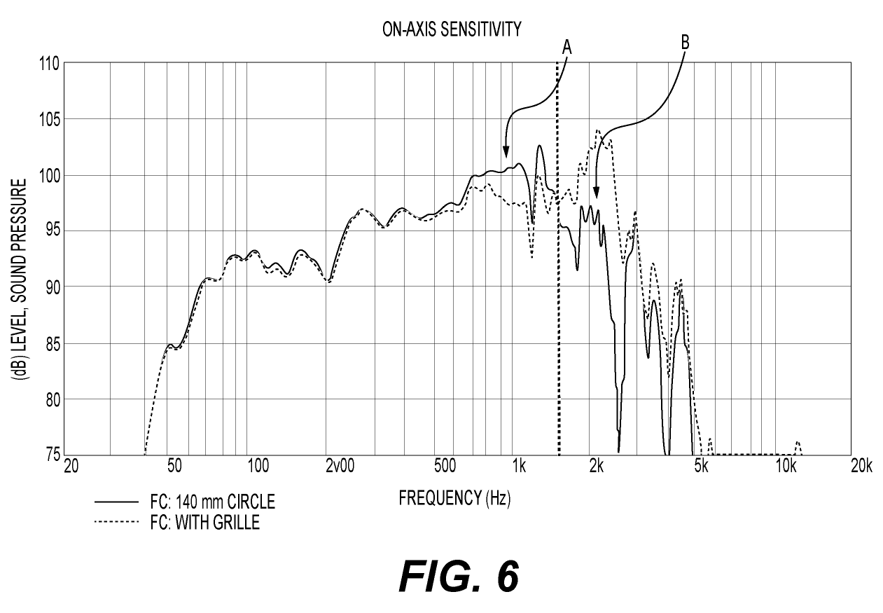

The inclusion of the acoustic filtering portion 130, 330, 430 integrated with the grille 116, 316, 416 can be used to tailor the acoustic ways from the low-frequency driver. The tailoring may be designed to achieve one or more desired acoustical effect(s), as mentioned previously. For example, FIG. 6 illustrates on on-axis sensitivity plot with frequency along the x-axis and sound level along the y-axis. FIG. 6 compares the sound level produced by an example low-frequency driver with a 140 millimeter diameter circular acoustic filtering portion attached to the inner surface of a grille of the speaker versus the same low-frequency driver with the 140 millimeter diameter circular acoustic filtering portion removed from the inner surface (i.e., no acoustic filtering portion). The crossover point for this example speaker is 1500 Hz.

As shown in FIG. 6, using the acoustic filtering portion with the grille, increases on-axis sensitivity of the low-frequency driver at frequencies just below the crossover point, as indicated by letter A in FIGURE, as compared to the grille with no acoustic filtering portion. In the illustrated embodiment, for example, on-axis sensitivity is greater for the low-frequency driver with the grille with integrated acoustic filtering portion for most frequencies between 700 Hz to 1500 Hz (as much as 3 dB greater) than the low-frequency driver with a conventional grille without an integrated acoustic filtering portion.

In addition, using the acoustic filtering portion with the grille, results in decreasing sound level (i.e. cutting off) for frequencies after the crossover point, as indicated by letter B in FIG. 6. Thus, the acoustic filtering portion improves sensitivity of the low-frequency driver right before the crossover point, where a user would want improved sensitivity, and decreases sensitivity after the crossover point, where the low-frequency driver is not utilized.

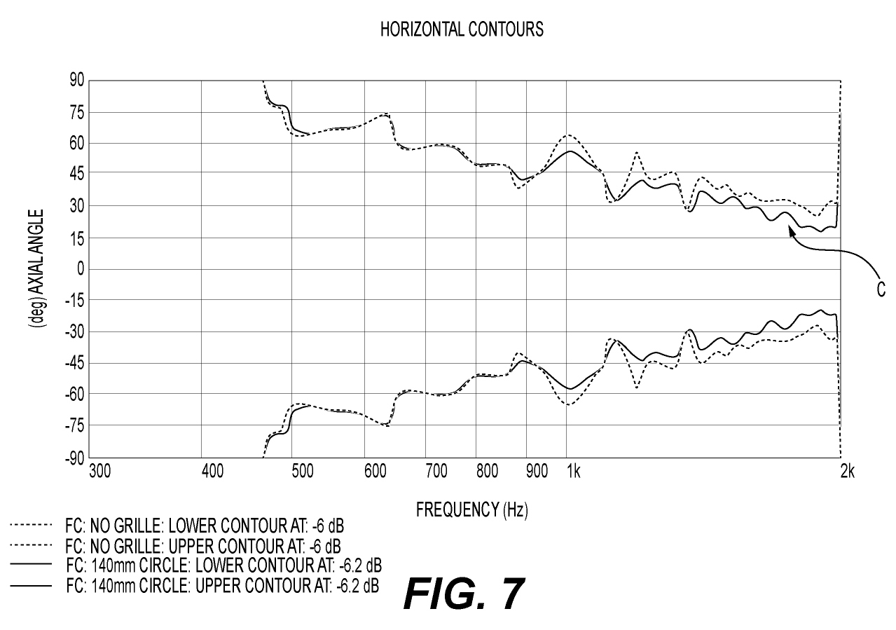

FIG. 7 illustrates a horizontal directivity contour plot that compares directivity of the an example low-frequency driver with a 140 millimeter diameter circular acoustic filtering portion attached to the inner surface of a grille of the speaker versus the same low-frequency driver with the 140 millimeter diameter circular acoustic filtering portion removed from the inner surface (i.e., no acoustic filtering portion).

As shown in FIG. 7, using the acoustic filtering portion with the grille, results in a narrower coverage indicated by letter C in FIG. 7. In the illustrated embodiment, for example, the sound is more focused or “beamed” in front of the low-frequency driver with the grille with the integrated acoustic filtering portion, especially in frequencies in the range of 950 Hz to 2000 Hz (as such as 7-8 degrees).

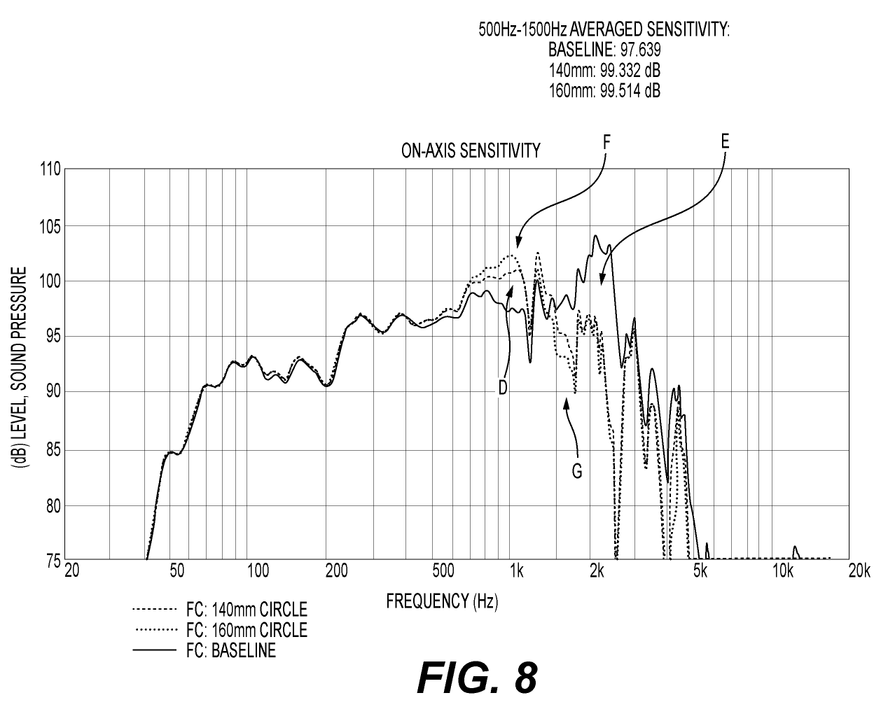

FIG. 8 compares the sound level produced by an example low-frequency driver with a 140 millimeter diameter circular acoustic filtering portion attached to the inner surface of a grille of the speaker versus a 160 millimeter diameter circular acoustic filtering portion attached to the inner surface of the grille of the speaker versus the same low-frequency driver with no acoustic filtering portion (i.e., the circular acoustic filtering portion removed). The crossover point for this example speaker is 1500 Hz.

As shown in FIG. 8, using either the 140 mm or the 160 mm acoustic filtering portion with the grille, increases on-axis sensitivity of the low-frequency driver at frequencies just below the crossover point, as indicated by letter D in FIG. 8, and decreases sound level (i.e. cutting off) of frequencies after the crossover point, as indicated by letter E in FIG. 8, as compared to using the grille with no acoustic filter portion.

Further, increasing the size of the acoustic filtering portion from 140 mm diameter to 160 mm diameter further increases on-axis sensitivity of the low-frequency driver at frequencies just below the crossover point, as indicated by letter D in FIG. 8, and decreases sound level (i.e. cutting off) of frequencies after the crossover point, as indicated by letter E in FIG. 8. Thus, the size of the acoustic filtering portion relative to the size of the low-frequency speaker driver may impact acoustic performance. For example, for at least some embodiments, increasing the size of the acoustic filtering portion may increase on-axis sensitivity of the low-frequency driver at frequencies just below the crossover point and/or may improve control over directivity of the low-frequency waves.

Thus, the disclosed acoustic filtering portions 130, 330, 430 may significantly enhance the ability to control the directivity of low frequency waves in the loudspeaker 100, boost frequencies below the crossover point, and cut off frequencies in that crossover range, leading to improved sound quality and more precise acoustic performance. The disclosed acoustic filtering portion 130, 330, 430 may be used allow a grille to block sound from one speaker driver (e.g., the low frequency speaker driver) resulting in affecting the sound of another speaker driver (e.g., the high frequency speaker driver) by limiting the crossover range of the low frequency speaker driver and a high frequency speaker driver.

In some embodiments, the acoustic filter portion may be configured to increase sensitivity in the low frequency range below the crossover point and narrow coverage of the low frequency speaker driver to better match coverage of high frequency speaker driver. In some embodiments, the acoustic filtering portion may be designed to enhance sensitivity just below the crossover point to ensure that the low frequency waves are directed effectively without interfering with the high frequency waves.

In some embodiments, the invention may provide enhanced control over the directivity of low frequency waves, allowing for more precise sound dispersion. This may be particularly useful in applications where specific coverage patterns are required, such as in point-and-shoot loudspeakers. In some embodiments, configuring the acoustic filtering portion to block certain high frequencies may boost the sensitivity of the low frequency speaker driver 108 in the desired frequency range. This may result in a clearer and more focused sound output from the loudspeaker 100.

The disclosed acoustic filtering portion offers flexibility in design, allowing for adjustments based on the specific requirements of different loudspeaker models. This adaptability ensures that the directivity can be tailored to various acoustic environments and applications.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A loudspeaker having a grille-integrated acoustic filter, comprising:
a low frequency speaker driver;
a high frequency speaker driver;
an enclosure configured to house the low frequency speaker driver and the high frequency speaker driver;
a grille configured to attach to a front portion of the enclosure to cover at least the low frequency speaker driver, the grille having an inner face; and
an acoustic filter portion that is one of attached to the inner face of the grille or formed as an acoustically non-transparent portion of the grille, wherein the acoustic filter portion is configured to reflect sound waves from the low frequency speaker driver in order to increase sensitivity in a low frequency range below a crossover frequency and narrow coverage of the low frequency speaker driver.

2. The loudspeaker of claim 1, wherein the loudspeaker is a passive loudspeaker.

3. The loudspeaker of claim 1, further comprising a crossover circuit configured to receive an audio input signal, to separate the audio input signal into a high frequency band and a low frequency band, and to transmit the high frequency band to the high frequency speaker driver and the low frequency band to the low frequency speaker driver, wherein the high frequency band and the low frequency band are separated at the crossover frequency.

4. The loudspeaker of claim 1, wherein the inner face of the grille defines a low-frequency driver covering area and the acoustic filter portion is configured to cover 25% or more of the low-frequency driver covering area.

5. The loudspeaker of claim 1, wherein the acoustic filter portion is configured to cover 50% or more of the low-frequency driver covering area.

6. The loudspeaker of claim 1, wherein the acoustic filter portion is configured to cover 75% or more of the low-frequency driver covering area.

7. The loudspeaker of claim 1, wherein the acoustic filter portion is circular or oval shaped.

8. The loudspeaker of claim 1, wherein the grille includes a perforated portion and the acoustic filter portion is a non-perforated portion of the grille.

9. The loudspeaker of claim 1, wherein the acoustic filter portion is attached to the inner face of the grille and is transparent to light.

10. A loudspeaker grille having an integrated acoustic filter, the loudspeaker grille comprising:
a grille body configured to attach to a front portion of a speaker enclosure, the grille body having an inner face defining a speaker driver covering area; and
an acoustic filter portion that is one of attached to the inner face or formed as an acoustically non-transparent portion of the grille, wherein the acoustic filter portion is configured to cover a least a portion of the speaker driver covering area, wherein the acoustic filter portion is configured to increase sensitivity in a low frequency range below a crossover frequency and narrow coverage of a low frequency speaker driver.

11. The loudspeaker grille of claim 10, wherein the acoustic filter portion is configured to cover 50% or more of the driver covering area.

12. The loudspeaker grille of claim 10, wherein the acoustic filter portion is configured to cover 75% or more of the driver covering area.

13. The loudspeaker of claim 10, wherein the acoustic filter portion is circular or oval shaped.

14. The loudspeaker of claim 10, wherein the grille includes a perforated portion and the acoustic filter portion is a non-perforated portion of the grille.

15. The loudspeaker of claim 10, wherein the acoustic filter portion is attached to the inner face of the grille and is transparent to light.

16. A method for increasing sensitivity of a loudspeaker in a low frequency range below a crossover frequency, the method comprising:
creating an acoustically non-transparent portion of a grille for the loudspeaker; and
attaching the grille to the loudspeaker such that the acoustically non-transparent portion extends across at least a portion of a driver covering area of the grille, wherein the driver covering area of the grille overlays a low-frequency speaker driver front area of a low-frequency speaker driver of the loudspeaker such that the acoustically non-transparent portion blocks at least a portion of an audio output of the low-frequency speaker driver.

17. The method of claim 16, wherein the acoustically non-transparent portion extends across at least 50% of the driver covering area of the grille.

18. The method of claim 16, wherein the acoustically non-transparent portion extends across at least 75% of the driver covering area of the grille.

19. The method of claim 16, wherein creating the acoustically non-transparent portion of the grille for the loudspeaker comprises creating a non-perforated portion of the grille.

20. The method of claim 16, wherein creating the acoustically non-transparent portion of a grille for the loudspeaker comprises attaching an acoustically non-transparent material to an inner surface of the grille.
